(19) United States
(12) Patent Application Publication
(10) Pub. No.: US 2006/0082844 A1
(43) Pub. Date: Apr. 20, 2006

(54) Process color with interference pigments

(76) Inventor: Don Michael White, Mt. Pleasant, TX (US)

Correspondence Address: D.M. White, 515 Alan Dr., Mt. Pleasant, TX, 75455-6041, US

(21) Appl. No.: 10/965,475

(22) Filed: Oct. 14, 2004

(51) Int. Cl. H04N 1/46

(52) U.S. Cl. 358/504

(57) ABSTRACT

An additive system for process color separation and printing using interference pigments is provided. The primary colorant materials are interference red (111), interference green (113), interference blue (114), and interference gold or yellow (112). These primaries are designated as R′G′B′Y′ (110) to distinguish them from the additive RGB (120) red (121), green (122), and blue (123) primaries used in conventional video, and the subtractive CMYK (220) cyan (225), magenta (221), yellow (223), and black primaries used in conventional process color printing. Separations are produced by a matrix transformation (350) from RGB color space to R′G′B′Y′ color space. A halftone transfer curve (420) is used to maximize highlight detail and color intensity. Stochastic halftoning is recommended. Conventional white substrates are replaced by black substrates, and the conventional use of positive and negative images is reversed. Otherwise, the R′G′B′Y′ prints are produced by the same methods and devices as conventional CMYK prints.

### FIELD OF INVENTION

This invention relates to process color separation and printing, specifically the use of interference pigments to produce a full color image with a brilliant metallic finish.

### BACKGROUND

### Color Theories

Physicists, chemists, and astronomers are concerned with the colors of the spectrum. The various colors of emitted, transmitted, or reflected light provide clues to the fine structure of matter. Colors are usually specified by wavelength. Instruments have enabled investigations to extend well beyond the visible spectrum.

Biologists, physiologists, and psychologists are concerned with the perception and response to colors exhibited by living organisms. Color vision in humans, color communication in mollusks, and photosynthesis in plants are some representative examples of these investigations.

Artists, engineers, and designers are concerned with the practical production and reproduction of colors. They are also concerned with the psychological influence of colors on the human emotions. They often must consider the physical and chemical properties of color materials, such as durabilty and toxicity.

The sensation of color can be produced by many different dyes, pigments, light modifiers, or light emitters. A set of colors that can be mixed to produce a larger range of colors is known as primary colors or primaries. The range of colors produced by a particular set of primaries is known as the gamut of that set.

Hue is the quality of a color that distinguishes that color from other colors. For instance, a red hue differs from a green hue. Hue is often represented on a 360° color wheel.

Chroma is the purity of a color. For instance, a bright red has higher chroma than a dull red. Saturation, intensity, and colorfulness are some approximate synonyms for chroma, although the precise definitions and quantitative measures differ.

Value is the lightness of a color. For instance, a pink has a higher value than a dark red. Brightness, lightness, darkness, reflectivity, and density are some approximate synonyms for value, although the precise definitions and quantitative measures differ.

The primary colors blue, red, and yellow have been known and used since antiquity. A set of pigments of these colors can be mixed to produce a complete range of hues, although they cannot produce a complete range of chroma nor values. Many color wheels and color charts have been produced with this type of system.

In 1905, A. H. Munsell published a system of color notation based on hue, chroma, and value. In 1915, this notation system was embodied in a color atlas. The Munsell system, with some alterations, remains an effective tool for the specification of colors. The sample colors shown in the Munsell atlas can be matched by many different mixes of pigments, dyes, or lights.

Early in the 20th Century, it was recognized that a system for the quantification of colors was needed for the specification of manufactured lighting, pigments, and dyes. The Commission International de I'Eclairage (International Commission on Illumination or CIE) was formed for the purpose of establishing these standards. After extensive research on the quantitative matching of colors by the mixing of three colored lights, a practical trichromatic theory of color mixing was defined by the CIE 1931 (r,g) Chromaticity Diagram. The three dimensional system of red, green and blue was mapped onto the two dimensional (r,g) plane. This was an attempt to model the color sensitivity of the human optical system, even before the biochemical, neurological, and psychological factors of color vision were as well understood as they are today. A significant portion of the spectral colors could not be matched by mixing the standardized red, green, and blue lights, so this system required the use of negative numbers. The CIE 1931 (x,y) Chromaticity Diagram was introduced at the same time; it was a coordinate transformation of the rgb system that was made in order to keep all of the numbers positive. The CIE 1960 (u′,v′) Uniform Color Space Chromaticity Diagram was an improved system which depicted the distances between different colors more accurately. The CIE 1976 (u′, v′) Uniform Color Space Chromaticity Diagram was a subsequent refinement of the 1960 diagram. The (u′,v′) diagram is widely used for the characterization of additive RGB video displays.

On the chromaticity diagrams, the outer boundary or “horseshoe” represents the limit of normal human color vision. The curved portion of the boundary is called the spectrum locus and represents the natural spectrum; it is numbered by wavelengths in nanometers. The straight line across the bottom of the diagram is called the purple line and represents the colors perceived when red and blue lights are mixed; wavelengths are not associated with this portion of the diagram.

These chromaticity diagrams, while convenient for depicting the perceptual differences between colors, do not necessarily imply a one-to-one relationship between any given color and the point depicted on the diagram. The sensation of a particular color may be produced by a single spectral color or by a mixture of two or more quite different colors. Differing mixtures having the same color appearance are known as metamers. The perceived colors of metamers may no longer match when viewed under different light sources.

In 1976 the CIE introduced two three-dimensional color spaces, the L*u*v* (CIELUV) and the L*a*b* (CIELAB) systems. Of the two systems, only the L*a*b* system has found wide application. The L* stands for Lightness, the a* is a magenta/green axis, and the b* is a yellow/blue axis. The CIELAB system also includes formulas for chroma and hue (CIELCH). The CIELAB system is widely used in the color materials and color reproduction industries. Other CIELAB type systems have been developed, and this type of system remains an active area of research.

Colorimetry continues to depend on the original CIE data. The complete characterization of any particular colorant material requires a spectrophotometric reading across the entire visible spectrum. Then the curve must be integrated by summation with respect to tables of established RGB data. Then the XYZ tristmulus values can be calculated and the color can be graphed on a chromaticity diagram or converted into one of the three-dimensional color spaces.

Two competing theories of human color vision persisted well into the 20th Century. The Young-Helmholtz theory was based on the mixing of colored lights (as in the CIE trichromatic system). It was assumed that the eye had red, green, and blue receptors that blended these primaries into the full range of perceived colors. The Hering theory considered a different set of primaries in opponent pairs: white/black, red/green, and yellow/blue. Paradoxically, experimental data provided support for both theories. This paradox has been resolved. Advances in physiological research have revealed that the color sensitivities of the cone receptors are approximately the same as those proposed by the Young-Helmholtz theory. And advances in psychological research have revealed that the sensations of colors are processed by the brain in the manner proposed by the Hering theory. In 1955 the Hurvich-Jameson theory was published; this theory incorporates both earlier theories.

### Color Technologies

Conventional television and video displays use the additive primaries red, green, and blue, which are similar to the CIE primaries. The colors of the phosphors of cathode ray tubes should be standardized for television and internet use, but continuing improvements in technology result in continuing improvements of the standards. This is especially true for newly developed technologies such as liquid crystal, light emitting diode, and plasma displays. Video cameras, digital still cameras, and three-channel scanners use filters that closely match the display colors. The characterization of RGB input and output devices is a relatively straightforward operation, because additive RGB technologies can be designed to approach a near perfect match to the theoretical RGB primaries.

Conventional process color printing and photography use the subtractive primaries cyan, magenta, and yellow (CMY) which are the modern equivalents of the traditional blue, red, and yellow. In printing, a black ink is usually added, because accompanying text is usually printed in black (CMYK). This type of printing is conventionally done on a white substrate. If it is desired to print CMYK on a black or other dark colored substrate, then a solid white ink must be printed first.

The ink sets used for CMY printing are designed so that each color subtracts one of the RGB additive colors. Cyan ink subtracts red light and transmits both blue and green light. Magenta ink subtracts green light and transmits both red light and blue light. Yellow subtracts blue light and transmits both red light and green light. The cyan image is made with a red filter; the magenta image is made with a green filter; the yellow image is made with a blue filter. (In CMYK printing, the black image is often made by making a one-third exposure with each of the red, green and blue filters. It may also be made with a yellow filter.) The organic dyes used to make the CMY inks do not approach theoretical perfection. Cyan inks absorb some green light and a small amount of blue light. Magenta inks absorb some blue light and a small amount of red light. Only the yellow inks are near theoretical perfection. Because of these color deficiencies of the cyan and magenta inks, color correction is required to achieve acceptable color reproduction.

Color correction was formerly done on film by one of many masking and/or compositing techniques. The color separations often required correction by hand (etching). Photographic color separation and correction techniques were developed by extensive trial and error. These techniques were as much an art as a science, and were often held as trade secrets.

Under Color Removal (UCR) and Gray Color Removal (GCR) techniques are used to replace the cyan, magenta and yellow inks with black ink in black, neutral gray, and desaturated color areas of a printed image. Essentially the black ink carries most of the image detail and density, while the colored inks add color only as needed. The UCR and GCR methods increase print contrast, improve gray balance, and reduce the required quantities of colored inks. These techniques also reduce color instabilities due to random variations in the printing process. When more than three inks are printed, the probability of moiré (objectionable patterns that are an artifact of halftone angles and frequencies) increases with each additional ink. Color removal methods also decrease the probability of moiré patterning.

More recently, color separation and correction has been done by the electronic equivalents of the earlier photographic techniques. A current method of color correction is the preprinting of color charts (print grids or ink patches) consisting of as many combinations of colors as is practically possible. The printed charts are then characterized by CIE colorimetry. Then digital look-up-tables (LUTs) are constructed and used to convert from RGB to CMYK. Other methods include the use of neural networks, matrix transformations, or predictive analytical models such as the DeMichel-Neugebauer system of equations. The search for improved color correction algorithms remains an ongoing problem.

Another significant deficiency of the organic dyes used in CMY printing and photography is that they are chemically unstable and fade with time and exposure to light. This fading takes place regardless of the vehicle or the substrate. Sometimes ultraviolet resistant varnishes are used to protect the color images, but these increase the expense of printing and are only partially effective for reducing the fading of the colors. Sometimes pigments are added along with the dyes to decrease fading, but this method reduces the transparency of the inks and introduces more difficulties into the color correction process.

Expanded ink sets that add other colors of inks to the conventional CMYK set extend the gamut of printed colors. These inks are also subject to fading. In fact, in those expanded ink sets with fluorescent dye contents, the fading can be worse than that of conventional CMY inks. Expanded ink sets require increasingly complex methods of color separation and correction. Therefore, extensive color charts must be printed and calorimetrically characterized. The use of large LUTs is required to maximize GCR and minimize the probability of moiré patterning.

For a special effect, CMYK printing is sometimes done on a metal foil substrate. The metallic finish is desirable both artistically and commercially. It is especially effective for book covers, posters, greeting cards, gift wrapping papers, wallpapers, and retail packaging. Metal foils are expensive and require more careful handling than paper. The inks are not absorbed by metal foils as they are in paper, and are therefore more likely to smear.

Techniques for incorporating metallic inks into selected portions of CMYK images have also been developed. Although these techniques produce attractive images, they are also expensive to produce.

### Interference Pigments

Interference pigments differ from conventional pigments and dyes in that their colors are derived from the laws of physics, rather than chemistry. The most common types in current use are composed of mica flakes coated with titanium dioxide. These types of pigments are chemically inert. They are nontoxic and environmentally safe. The only health hazard associated with these colorant materials is the danger of inhalation (silicosis) when handling the dry powders.

Another type of interference pigment is made of basic lead carbonate. The use of these materials is declining, because they are toxic, and because the flakes are subject to breakage during processing.

The titanium dioxide-mica interference pigments are extremely stable, both chemically and physically. They show no fading on exposure to light. Their permanence is only limited by the permanence of the vehicle and substrate.

There has been a great deal of recent innovation in the field of interference pigments. There are several different types: subtle pearlescent colors, metallic colors, glitter colors, and intense primary colors. Goniochromatic pigments that shift color with the angle of view have also been developed. These pigments are readily available from several manufacturers. Interference pigments are popularly used in automotive paints, art paints, printing inks, cosmetics, marking pens, and children's crayons.

Printing with interference pigments can be done using any printing technology that is capable of carrying particulate pigments. These printing processes include, but are not limited to, screen printing, letterpress, lithography, xerography, collotype, wax transfer, and adhesive polymer. Recent advances in manufacturing have produced interference pigments suitable for the more fluid inks used in flexography, gravure, and inkjet systems.

The interference pigments can be incorporated into almost any vehicle including, but not limited to, aqueous emulsions or solutions, drying oils, organic solvents, polymers, waxes, powdered toners, and powdered frits. The interference pigments can be used on almost any substrate material including, but not limited to, paper, cloth, wood, plastic, metal, glass, ceramic, and stone.

Interference pigments have been incorporated into photographic silver halide emulsions to produce monochrome original prints. It has also been proposed to incorporate interference pigments into differentially sensitized layers of silver halide emulsions to produce multicolored original prints. These techniques have had very little commercial success.

Interference pigments have been mixed with standard CMY printing inks and toners to enhance the color saturation and permanence of these materials.

### Objects and Advantages

The main object of this invention is to create a process color system using interference pigments instead of the dyes used in conventional process color systems.

Another object of this invention is to create a process color system that can be used with existing devices.

Another object of this invention is to produce printed products that have a full range of colors.

Another object of this invention is to produce printed products that have a full range of density or reflectivity, from black to white with all intermediate values.

Another object of this invention is to produce printed products that have image detail comparable to conventionally printed products.

Another object of this invention is to produce printed products that have a brilliant finish that resembles burnished metal.

Another object of this invention is to produce printed products that are inexpensive in comparison to other methods of metallic printing.

Another object of this invention is to produce printed products that are lightfast and nonfading.

Another object of this invention is to produce printed products containing nontoxic and environmentally safe colorant materials.

Another object of this invention is to produce printed reproductions of original artworks created with interference pigments.

Another object of this invention is to produce printed representations of those biological organisms which exhibit iridescent colors due to interference effects.

Other objects and advantages will be obvious, and others will be apparent from the specification.

### BRIEF DESCRIPTION OF THE DRAWING FIGURES

FIG. 1 shows the gamut of the R′G′B′Y′ additive color system compared to prior art, the gamut of a typical RGB additive color system, Trinitron™ video phosphors.

FIG. 2 shows the gamut of the R′G′B′Y′ additive color system compared to prior art, the gamut of a typical CMY subtractive color system, Specifications for Web Offset Printing (SWOP).

FIG. 3 shows a flowchart for the initial calibration of the R′G′B′Y′ color separation and printing system.

FIG. 4 shows a flowchart for the preferred mode of color separation using a matrix transformation from RGB color space to R′G′B′Y′ color space.

FIG. 5 shows a flowchart for an alternate direct mode of color separation using a four-color R′G′B′Y′ set of filters with otherwise conventional four-color photomechanical devices.

### DETAILED DESCRIPTION OF THE DRAWING FIGURES

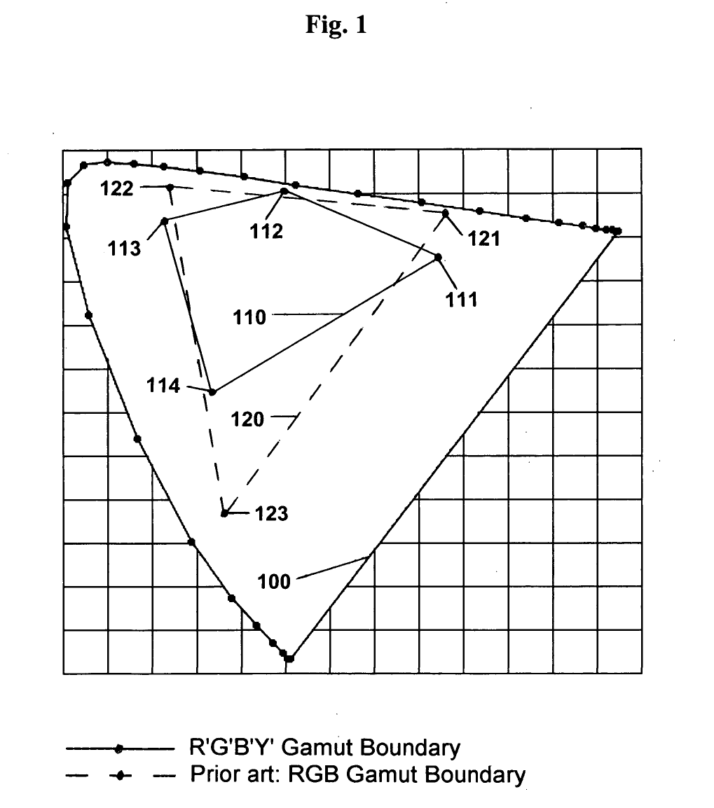

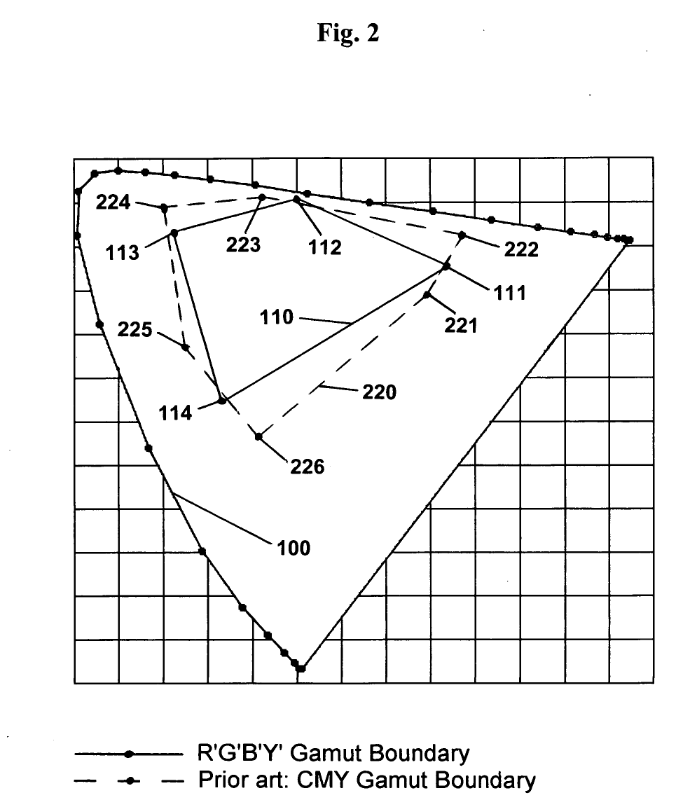

The CIE 1976 (u′,v′) Uniform Color Space Chromaticity Diagram is used for the gamut comparisons shown in FIGS. 1 and 2. This diagram is selected because of its conventional use for the comparison of different RGB color systems and devices in the video and computer graphics industries. Straight lines on the CIE 1931 (x,y) diagram remain straight on the u′,v′ diagram; this is not the case on the a*,b* diagram.

In FIG. 1 the solid line labeled 100 represents the outer boundary of normal human color vision; the solid line labeled 110 represents the outer boundary of the R′G′B′Y′ gamut; the point labeled 111 represents the color of interference red; the point labeled 112 represents the color of interference yellow; the point labeled 113 represents the color of interference green; the point labeled 114 represents the color of interference blue; the dashed line labeled 120 represents the outer boundary of the RGB gamut; the point labeled 121 represents the color of video red; the point labeled 122 represents the color of video green; and the point labeled 123 represents the color of video blue.

In FIG. 2 the solid line labeled 100 represents the outer boundary of normal human color vision; the solid line labeled 110 represents the outer boundary of the R′G′B′Y′ gamut; the point labeled 111 represents the color of interference red; the point labeled 112 represents the color of interference yellow; the point labeled 113 represents the color of interference green; the point labeled 114 represents the color of interference blue; the dashed line labeled 220 represents the outer boundary of the CMY gamut; the point labeled 221 represents the color of magenta ink; the point labeled 222 represents the red color formed by combining magenta and yellow inks; the point labeled 223 represents the color of yellow ink; the point labeled 224 represents the green color formed by combining yellow and cyan inks; the point labeled 225 represents the color of cyan ink; and the point labeled 226 represents the blue color formed by combining cyan and magenta inks.

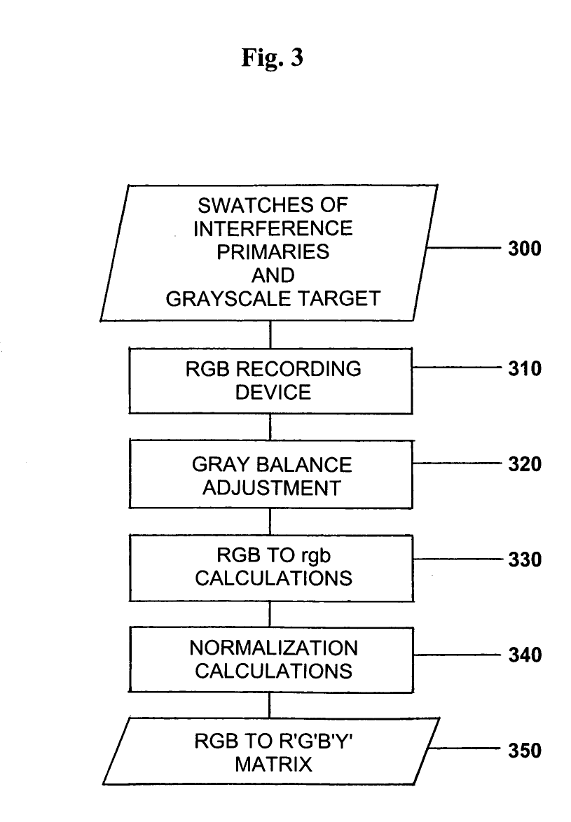

FIG. 3 shows a flow chart for the initial calibration of the R′G′B′Y′ color separation and printing system. The input labeled 300 is the target swatches of the four interference primaries combined with a grayscale target; at 310 a digital RGB image of the combined targets is recorded; at 320 the white, gray, and black balances of the RGB image are adjusted; at 330 the RGB digital counts are converted to rgb decimal values; at 340 the rgb decimal values are normalized; and the output at 350 is the RGB to R′G′B′Y′ transformation matrix.

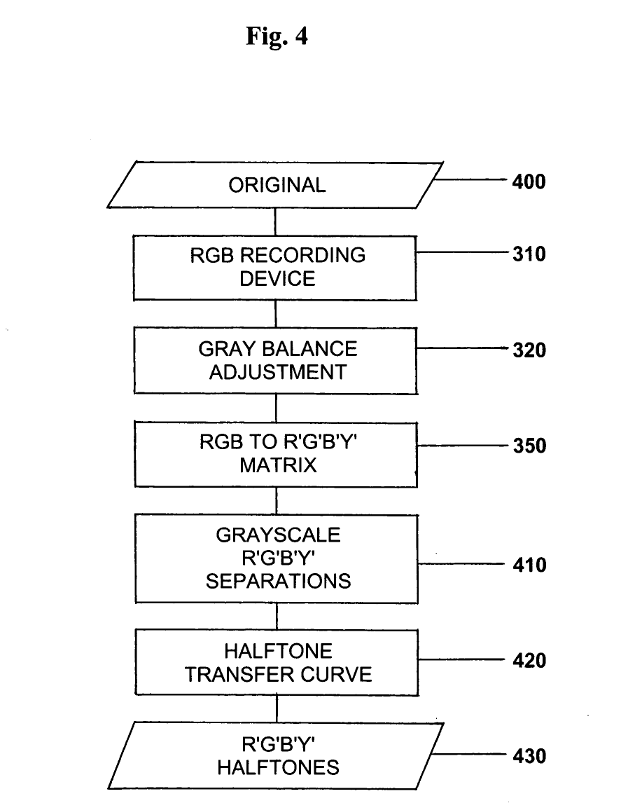

FIG. 4 shows a flowchart for the preferred mode of color separation using a matrix transformation from RGB color space to R′G′B′Y′ color space. The input labeled 400 is the original photograph, artwork, or other object; the input at 400 can also be an existing RGB file that has been transmitted or computer generated, in this case the steps at 310 and 320 are skipped; at 310 a digital RGB image of the original is recorded; at 320 the white, gray, and black balances of the RGB image are adjusted; at 350 the RGB digital counts are converted to R′G′B′Y′ digital counts; at 410 the grayscale R′G′B′Y′ separations are stored or transmitted; at 420 the halftone transfer curve is applied to the grayscale R′G′B′Y′ separations; and the output labeled 430 is the set of R′G′B′Y′ halftones.

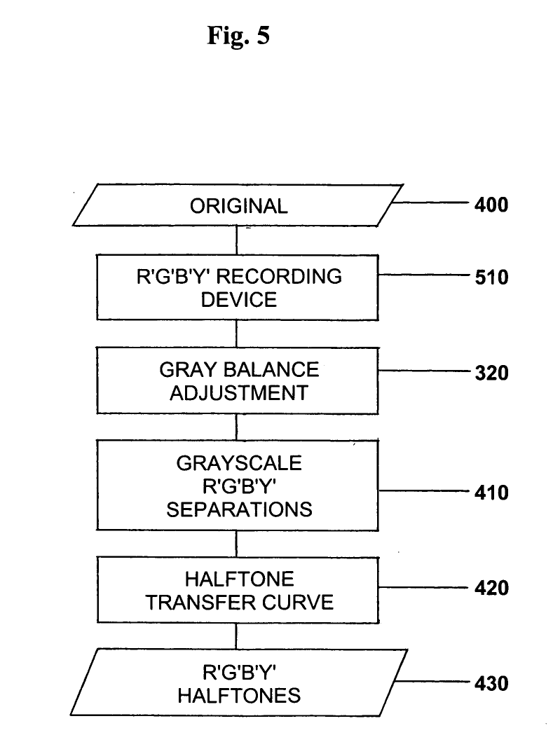

FIG. 5 shows a flowchart for an alternate mode of color separation using a four-color R′G′B′Y′ set of filters with otherwise conventional four-color photomechanical devices. The input labeled 400 is the original photograph, artwork, or other object; at 510 a photographic or digital set of R′G′B′Y′ images of the original is recorded; at 320 the white, gray, and black balances of the R′G′B′Y′ images are adjusted; at 410 the grayscale R′G′B′Y′ separations are stored or transmitted; at 420 the halftone transfer curve is applied to the grayscale R′G′B′Y′ separations; and the output labeled 430 is the set of R′G′B′Y′ halftones.

### SUMMARY

An additive process color separation and printing system that uses a selected set of interference pigments for the primary colors is provided. The selected primaries are interference red, interference green, interference blue, and interference gold (yellow).

The selected interference primaries are designated R′G′B′Y′ to distinguish them from the additive video primaries red, blue, and green (RGB), and the subtractive photographic and printing primaries cyan, magenta, and yellow (CMY). The R′G′B′Y′ primaries form an additive system of color mixing that is distinct from the additive RGB system and the subtractive CMY system.

The R′G′B′Y′ separations can be produced from RGB images by a simple matrix transformation. This method has the additional advantage of being easily reversed. This transformation is followed by the application of a halftone transfer curve. The RGB image may be obtained with a digital camera or scanner, or it may be transmitted or computer generated. The R′G′B′Y′ separations can be made by any type of photographic or electronic methods and means that are capable of producing CMYK separations.

Process color printing with the R′G′B′Y′ colors can be accomplished by any type of printing method that is capable of carrying particulate pigments, and of sequentially or simultaneously applying at least four colors of inks, waxes, toners, frits, or other suitable vehicles.

Process color printing with the R′G′B′Y′ colors requires the reversal of usual CMYK practice in that it is done on a black substrate rather than a white substrate. The R′G′B′Y′ printing is most effective on a matte substrate, where CMYK printing is most effective on a gloss substrate. Particulate pigments are used, where dyes are the usual practice. Separation filters are the same colors as the ink colors, where opponent color filters are the usual practice. Negatives are used where positives are the usual practice, and positives are used where negatives are the usual practice. Highlight detail is formed in the areas of high colorant density, where shadow detail is formed by the usual practice.

This new system of process color separation and printing is comprised of the objects, materials, means, and methods set forth in this specification. Explanations are provided for those objects, materials, means, and methods which are substantially different from the usual practice. Otherwise, the objects, materials, means, and methods which are parts of the usual practice are understood to be known to skilled practitioners of the art and science of process color separation and printing.

Theory of Operation

The intense primary color types of titanium dioxide-mica interference pigments are selected for process color printing. Further, the types that do not contain conventional subtractive colorants are selected. Further, the pigments having flakes in the smaller sizes are selected (10 to 40 micrometers). Other flake sizes are not excluded. For instance, the larger (glitter) flakes can be used for printed materials intended for longer viewing distances (billboards), or for a special effect. The colors of these pigments are at their maximum intensity when viewed with reflected light on a black substrate. These are available as inks, paints, and powdered pigments in the Munsell primaries gold (yellow), red, violet (purple), blue, and green. Because the purple can be matched by a mixture of the red and blue, the remaining four colors (yellow, red, blue, and green) are selected as primaries for process color printing. (This also shows that the five Munsell primaries do not meet the rigorous definition of primaries: no primary can be matched by any mixture of the other primaries.) The use of other colorant materials that meet the required criteria of color appearance as stated in this specification is not excluded.

Interference pigments are often described as having color intensity rather than color saturation, because their appearance is so different from conventional pigments and dyes. The color of an interference pigment shifts with the angle of view. The types of pigments that exhibit the minimum amount of color shift are selected as primaries. The color stability is further improved by printing on a matte substrate, because this method produces a color that is an average of the colors produced by many different angles. The use of other substrates is not excluded.

Unique colors are those colors that a significant majority of observers having normal color vision agree to be the most representative samples of named colors, such as the reddest red, the greenest green, the bluest blue, and the yellowest yellow. The selected interference primaries satisfy this definition.

Opponent colors, also known as complimentary colors, are those colors that appear as afterimages. Research has shown that human visual perception groups these opponent colors into three pairs: black/white, red/green, and blue/yellow. This phenomenon is the basis of the Hering theory of human color vision. Because black equals no colors and white equals all colors, the selected interference primaries, when applied to a black substrate, satisfy this definition.

The CIELCH hue angles of the unique opponent colors are red 24°, green 162°, blue 246°, and yellow (gold) 90°. The peak wavelengths in nanometers are red 520c, green 520, blue 470, and yellow 580. The red (given as a complimentary wavelength) is technically a magenta, because it has a blue component. The interference pigments that most closely match these ideal specifications are selected.

Object colors can be regarded as perceptually invariant. An object of a particular color still appears as the same color under different lighting conditions, assuming that the spectral content of the light source is sufficient for the perception of colors. The selected interference primaries satisfy this definition. (This is not a rigorous definition, but a practical one.)

The selected interference primaries can be symbolized as R′G′B′Y′ to distinguish them from the additive RGB and the subtractive CMY primaries. The R′G′B′Y′ primaries form an additive system that is distinct from the additive RGB and subtractive CMY systems.

The mixing laws characteristic of the R′G′B′Y′ colors differ from those of both the RGB colors and the CMY colors. For instance, in the additive RGB system red plus green makes yellow; in the subtractive CMY system red (magenta plus yellow) plus green (cyan plus yellow) makes dark brown or black. In the R′G′B′Y′ system, red plus green makes gray.

TABS. 1 and 2 show the basic mixes of RGB and CMY colors, respectively. The RGB and CMY systems are opponents of each other with the pairs of red/cyan, green/magenta, and blue/yellow. In FIG. 2 the dashed line labeled 220 shows that the gamut of these colors, as embodied in the SWOP system, forms an irregular hexagon.

TAB. 3 shows the basic mixes of the R′G′B′Y′ colors. These are mixtures in equal ratios applied to a black substrate and viewed by reflected light. The system is shown to be additive, because the mixed colors are lighter than the pure primaries. On a white substrate viewed by reflected light, they show a palely colored pearlescent finish; the color varies with the angle of view from the named reflected color to the opponent transmitted color. On a transparent or translucent substrate viewed by transmitted light, they mix subtractively and show the opponent colors at a palely colored pastel level. The transmitted color is much weaker than the reflected color. Therefore, for the practical purpose of printing R′G′B′Y′ colorants on a black substrate, the transmitted color is ignored.

TAB. 3 also shows the insufficiency of tricolor sets selected from the four interference primaries. For instance, if red, green, and blue are selected, then yellow is unavailable; if blue, green, and yellow are selected, then red is unavailable; if green, yellow, and red are selected, then blue is unavailable; and if yellow, red, and blue are selected, then green is unavailable. The four colors red, green, blue, and yellow are necessary and sufficient to form a complete range of colors.

The mixing of colors in the R′G′B′Y′ system proceeds according to the Hering opponent color theory of human vision. The plots of gamuts shown in FIGS. 1 and 2 (solid lines labeled 110) show that the R′G′B′Y′ system of colors includes a sufficient portion of the chromaticity diagram to be used as the basis for a practical color reproduction system. The approximate gamut sizes as compared to the entire visible range are RGB 30%, CMY 28%, and R′G′B′Y′ 20%.

The R′G′B′Y′ separations can be made using any existing process that is capable of making CMYK separations. These separation processes include, but are not limited to, film cameras or enlargers, contact frames, digital cameras, analog or digital scanners, and general purpose computers running image processing software. Standard RGB images can be directly transformed into R′G′B′Y′ separations by a simple matrix operation. Matrix transformation has the additional benefit of being easily reversed. An additive color space can be transformed into another additive color space without the extensive color correction which is required to convert from additive RGB color space to subtractive CMYK color space. Geometrically, the transformation is from a three-dimensional vector space to a four-dimensional vector space, that is, from a cubic space to a hypercubic (tesseract) space.

The color separation matrix is directly derived from the RGB digital counts of the R′G′B′Y′ colors as recorded by a digital camera, scanner, or a mechanically or electronically controlled visual color matching device. The matrix consists of the rgb values of the R′B′G′Y′ colors. The complete CIE colorimetric characterization of the R′G′B′Y′ colorants is not required. The colors of the interference primaries have a large white content, approximately 35% for red, 44% for green, 22% for blue, and 27% for yellow. For the practical purpose of color separation, the matrix entries are normalized by setting the desaturating color of each row to zero and proportionally increasing the remaining two colors, which must sum to unity. The transformation can be regarded as converting a real RGB filter set into a virtual R′G′B′Y′ filter set. The normalization of the matrix has the effect of narrowing the bandwidths of the virtual R′G′B′Y′ filters. In other words, the white contents of the interference pigments are effectively ignored.

In conventional CMYK printing the dyes are known to mix in a subtractive manner. However, when a conventionally printed color halftone image is viewed, the colored dots are perceived as an additive mixture by the eye. Also, printing on a white substrate produces light scattering within the substrate which causes nonlinear interactions between the printed areas and the unprinted areas. These interactions also change as the printed areas increase or decrease. The R′G′B′Y′ process, as printed on a black substrate, is not subject to this complex type of ink/substrate interaction; the light scattering interactions only occur within the ink layers.

Halftone transfer curves for any number of overprinting inks can be generated from the general solution to the DeMichel-Neugebauer equations. The generating equation is an nth-degree polynomial of degree equal to the number of inks. EQU. 3 shows the solution for four inks with all four areas set as equal. TAB.7 shows the numerical values of a transfer curve calculated for four inks, normalized, converted to additive reciprocal percentages, and smoothed in the lowest five values. The high ink densities are in the highlights of the images, rather than in the shadows as in CMYK printing. This curve expands highlight detail, and only prints 100% of all four colors in the specular highlights of the images. By minimizing the probability of overprints in the shadow and midtone areas, and thus limiting the inherent destaturation caused by the considerable white contents of the interference pigments, this curve maximizes color intensity. Similar curves can be obtained by other methods, for instance, the logarithmic methods used for gamma calculations. Transfer curves are conventionally determined for particular printing presses, inks, and substrates. For example, dot gain is higher on a matte substrate than on a gloss substrate. Therefore, the curve given in TAB. 7 requires empirical adjustment for different printing methods, devices, and conditions.

In any random selection of images, all four of the interference primaries are of statistically equal weight. This precludes the use of conventional halftone angles, which would cause problems with moiré. A stochastic halftoning technique is recommended. These techniques include, but are not limited to, digital randomizing (dithering) algorithms, mezzotint contact screens, and photographic grain enhancement. The use of stochastic halftones has the additional benefit of enhancing the burnished metal appearance of the prints. The use of other methods of halftoning is not excluded. The use of dotless printing processes is not excluded. The video RGB colors are produced by light emitters in a dark matrix, the printing CMYK colors are produced by small filters on a white reflector, but the interference R′G′B′Y′ colors are produced by even smaller reflectors on a black substrate. In this sense, the interference pigments themselves form ideal stochastic halftone dots.

Metamers do not occur within the three-color systems, RGB and pure CMY (without black). In CMYK printing systems (and systems using more than four colors) the main function of the color removal methods is the preferential selection of those metamers containing black. The R′G′B′Y′ color space is relatively orthogonal, but CMYK color space is not, because of the black. The R′G′B′Y′ system has many metamers. For instance, a particular light red might be made with R′ and G′, or it might be made with R′, B′, and Y′, or it might be made with all four interference primaries. In the R′G′B′Y′ system, using the simple matrix transformation, the probabilities of the occurrences of the metamers with more than two colors are inversely proportional to the color intensity (saturation). This has the desirable effect of maximizing reflectance in the highlight areas of the image.

The technique of R′G′B′Y′ process color printing differs from conventional process color printing in that it is done on a black substrate, rather than a white substrate. Therefore, the conventional use of positive and negative films is reversed. For instance, in screen printing, where film positives are conventionally used to expose the stencils, film negatives are required; and in offset lithography, where film negatives are conventionally used to expose the plates, film positives are required. The images appear as negatives when printed with black ink on a white substrate. This reversal of usual practice is also applicable to other photomechanical and/or electronically controlled imaging systems.

In conventional CMYK printing the order in which the colors are printed can be an important factor. For instance, on single-color and four-color presses, the most common order is yellow, magenta, cyan, and black. This order minimizes the contamination of the lighter ink colors with the darker ink colors. For two-color presses the preferred order is yellow and black for the first run, and magenta and cyan for the second run. This order facilitates the adjustment of color balance. The yellow and black are the two least critical colors, so the first run is done “by the numbers”. In the second run both the overall balance and the magenta/cyan balance can be adjusted by visual inspection. In R′G′B′Y′ printing the preferred color order runs from the strongest to the weakest in color intensity: blue 78%, yellow 73%, red 65%, and green 56%. This order remains the same for two-color presses; in the first run the blue/yellow balance can be adjusted; and in the second run both the overall balance and the red/green balance can be adjusted. This order is reversed for transfer processes.

A summary comparison of some of the characteristics for RGB CRT displays, CMYK printing, and R′G′B′Y′ printing is shown in TAB. 8. It has long been believed that additive reflective color photography and printing are not possible, and this remains true when only conventional colorant materials are considered. The interference pigments, due to their reflective nature, make additive reflective color printing possible. In TAB. 8 CMYK printing is referred to as four-dimensional, but the dimensionality of the CMYK system can best be considered as relativistic. That is, the CMY components are analogous to the three spacial directions, while the K component is analogous to time. An even better analogy comes from molecular modeling, where the K component is analogous to atomic radius.

The R′G′B′Y′ system is a true Euclidean four-space. As such, it can be represented as a unit hypercube with vertex coordinates as given in TAB. 3. Slices through the color hypercube starting at the origin reveal the black point, the primary tetrahedron, the secondary octahedron (six vertices), the tertiary tetrahedron, and the quaternary white point. The longest diagonal is equal to two units, which agrees with the maximum value obtained with the four-color DeMichel-Neugebauer solution (EQU. 3). (The practical interpretation of this value is that the maximum effective printed dot area for four colors is 200%.) In this system, the value of each color remains positive and lies between zero and one. The hypercubic model of the R′G′B′Y′ system can also be used as the basis for a color difference formula, a color appearance model or a neural network (1-4-6-4-1 nodes).

### DESCRIPTION AND OPERATION OF THE MAIN EMBODIMENT

Conversion of an RGB image file to R′G′B′Y′ separations by a matrix transformation is selected as the best mode, because of the current prevalence of RGB images, and because this method requires a minimum amount of computation.

Screen printing is selected as the best mode, because it is capable of carrying a high pigment concentration, and because it is capable of printing with a wide variety of vehicles on a wide variety of substrates. Also, screen printing is often done on black or other dark colored substrates.

The primary interference pigments are mixed with clear ink base at a concentration near the ink manufacturer's recommended level for aluminum powders. This is a concentration of approximately 60 grams per liter (0.5 pounds per gallon). Mixing is done with a minimum of mechanical impact to the pigment flakes. The ink should not be ground on a slab, in a mortar, nor in a mill, because any crushing or breaking of the pigment flakes will degrade or destroy the interference effect. The ink is made as thin as possible for effective printing.

A flowchart for the initial calibration process is shown in FIG. 3. At 300 swatches of the inks are prepared on a black substrate and mounted alongside a grayscale target. At 310 an RGB image of the ink swatches and the grayscale target is obtained with a three-channel scanner or digital camera. At 320 the grayscale portion of the image is adjusted for color balance and the RGB values of the interference primaries are recorded. TAB. 4 shows the raw RGB values as an 8 bit digital count (0 to 255 scale). At 330 the RGB values are converted to rgb values (EQU. 1.1-3). The raw rgb values are shown in TAB. 5. At 340 the raw rgb values are normalized. The normalized rgb values as shown in TAB. 6 are used as the RGB to R′G′B′Y′ transformation matrix.

A flowchart for RGB to R′G′B′Y′ separation and halftoning is shown in FIG. 4. The original image at 400 is photographed or scanned at 310. At 320 the gray balance is adjusted. If the original image is already in digital RGB format, the steps at 310 and 320 are skipped. At 350 grayscale separations of the desired image are made by applying the matrix as in TAB. 6 (EQU. 2.1-4). At 410 the calculated images are saved as four grayscale files or one four-channel file. A four-channel R′G′B′Y′ file is the same size as a CMYK file of the same resolution. At 420 the halftone transfer curve is applied to the grayscale separations. The output at 430 is the set of R′G′B′Y′ halftones.

The use of a stochastic halftoning technique is selected as the best mode. The halftone frequency should be the equivalent of one-third (or less) of the screen mesh frequency. A one-fifth ratio is used. The stochastic equivalent of a 19.7 lines per centimeter (50 lines per inch) halftone is used with a 98.4 lines per centimeter (250 lines per inch) screen mesh (40% open area). Stainless steel screens are used for dimensional stability and durability. The stencil emulsion is selected for resolution and durability (dual cure type). The interference pigments are physically abrasive and cause more wear than conventional process inks. Since negatives are used instead of positives, a separate blockout exposure is required when exposing the stencils. The blockout exposure is combined with appropriate color bars and register targets.

Printing is carried out in the same manner as CMYK printing. A four-color densitometer can be used for quality control. If the densitometer has positive and negative settings, the negative setting is used. The blue ink is read with the yellow channel (blue filter), the yellow ink with the black channel (yellow filter), the red ink with the cyan channel (red filter), and the green ink with the magenta channel (green filter). Ink reflectivity is actually being read, instead of density. Once the printed proofs are obtained and the system dot gain is determined, further adjustment of the halftone transfer curve is made.

### DESCRIPTION AND OPERATION OF ALTERNATIVE EMBODIMENTS

Alternatively, a photomechanical method of color separation can be used. In one method, standard RGB separations are made and then composited to R′G′B′Y separations using the values in TAB. 6 to determine the exposures. Another method is to make multiple exposures on each of the R′G′B′Y′ separations, using the values in TAB. 6 and the known filter factors to determine the exposures. The values for the halftone transfer curves can be derived as in TAB.7 (EQU. 3). The flowchart in FIG. 4 is applicable to these methods.

Narrowband gel filters can be selected for making direct separations with conventional photomechanical equipment. The same four filter set can also be used in a four-channel scanner or densitometer. Interference filters can be used in the light source path. A spectral type scanner with tunable filters can also be used. The values for the halftone transfer curves can be derived as in TAB.7 (EQU. 3). The flowchart in FIG. 5 is applicable to these methods.

A soft proof can also be made by converting the grayscale R′G′B′Y′ separations to RGB format, setting their colors to match the raw digital counts (TAB. 4), and then recombining them into one RGB image.

Color separations can also be produced by printing color charts with many combinations of halftone dot percentages. Then the charts are scanned, digitally photographed, or otherwise calorimetrically characterized. Then the colorimetric data is placed in an LUT and used to produce the separations. Since the RGB to R′G′B′Y′ transformation is easily accomplished, there is no real need for such a complex method. However, this type of chart is useful to designers for the specification of spot color mixes. A 7×7×7×7 chart made up of 0%, 16.7%, 33.3%, 50%, 66.7%, 83.3%, and 100% of each primary shows 2,401 different color combinations. This is a reasonable size. For instance, the Munsell system has more than 1,500 colors, the Swedish Natural Color System also has more than 1,500 colors, Colorcurve has 2,156 colors, Pantone has 1,012 spot colors and 942 process colors, and Trumatch has more than 2,000 process colors. The complete CIE colorimetric characterization of such a chart is a long and tedious task.

For a special effect, R′G′B′Y′ printing can also be done on a substrate of a color other than black. A subset of the R′G′B′Y′ colors can be selected to compliment the colored substrate. For instance, R′, G′, and Y′ can be printed on a blue substrate. Many other combinations are possible.

A fifth separation can be produced from the four R′G′B′Y′ separations to make a skeleton white. This white is an interference white, designated W′. This method increases highlight detail, contrast, and reflectance.

Process color printing with interference pigments can also expand the uses of color in those printing and decorating technologies in which dyes cannot be used because of harsh conditions in processing or use.

The R′G′B′Y′ inks can be used on or in a transparent or translucent substrate by printing the opponent colors of the separations. This produces a pastel colored “stained glass” effect when viewed by transmitted light.

The R′G′B′Y′ pigments can also be incorporated into frits for process color printing on glass, metal, ceramics, stone, or other hard materials. Frits are conventionally applied by screen printing. The frits should have a melting point below 600° Celsius (1112° Fahrenheit) and a refractive index close to that of mica (approximately 1.58 dimensionless). The frits should flow enough in firing to produce a smooth, thin coating. This technique can be especially effective on a matte black glass, ceramic, or anodized metal surface.

Offset lithography is one of many alternative printing processes that can be used for R′G′B′Y′ printing. Lithographic applications with four-color presses are limited by the availability of black substrates. However, a six-color press can print (1) black, (2) interference blue, (3) interference yellow, (4) interference red, (5) interference green, and (6) a clear varnish, interference white, or spot color. This six-color method enables black text to be printed on a white substrate along with interference images or display type on the preprinted black areas. A similar sequence would be printed by letterpress, flexography, or gravure. Inkjet, wax transfer, xerography, collotype, and adhesive polymer systems can be used for custom imaging and/or proofing.

Dotless R′G′B′Y′ printing can also be done by a process capable of depositing continuously varied amounts of inks or toners. Collotype is a dotless system that can be used. In this printing method, the reticulations of the hardened gelatin function as stochastic halftone dots.

Ramifications

The most transparent and the least goniochromatic interference pigments are the best for process printing purposes. As the manufacturing technologies for interference pigments continue to be refined, sets of color materials can be specifically designed for process color printing. The required manufacturing improvements are better controls of flake sizes and coating thicknesses. The goals of these improvements are more stable peak wavelengths and narrower bandwidths (reduced white contents). Materials other than titanium dioxide-mica are in current development as well.

An interference pigment set could be produced that would closely match the standard RGB video colors. Such a set of RGB pigments would make a three-color process possible. This would further simplify the color separation procedure. However, printing with three colors would produce less total reflectance than printing with four. With the number of four-color devices available, the skeleton white mentioned above could be used to increase the contrast and brightness of the print (RGBW′).

A pigment set could also be designed and manufactured to match the CIELAB primaries. Separations would be made by converting from RGB to CIELAB and then to magenta, green, blue and yellow (M*G*B*Y*). These colors can be premixed from the selected R′G′B′Y′ primaries, with the addition of interference violet. However, this type of mixing decreases the color intensity (saturation) of the system. The unique opponent primaries form a larger gamut.

Expanded sets of interference pigments could also be designed. Process printing with these sets of pigments would require extensive color charts, calorimetric characterization, and the use of LUTs or more complex color appearance models. Process printing done with expanded sets of improved interference pigments could approach a true spectral reproduction.

### CONCLUSION

Process color printing with interference pigments produces a highly reflective finish resembling burnished metal, a full range of brilliant colors, and image detail comparable to conventional process color printing. It also produces high mechanical durability and high lightfastness. The titanium dioxide-mica types of interference pigments are nontoxic and environmentally safe. The pigments are also inexpensive. The only drawback to their use in printing systems is the abrasive quality of the pigment flakes, which contributes to increased wear of stencils and plates as compared to inks containing dyes.

The R′G′B′Y′ process is not intended to replace conventional CMYK processes; it provides a new kind of process color separation and printing system in addition to existing systems. The R′G′B′Y′ process can be accomplished with existing devices, therefore, initial investments are small. The only requirements are a change of colorant materials, a change of substrates, and a change of color separation methods. In the common use of screen printing on black or other dark colored surfaces, the change of substrates is not required.

Process color printing with interference pigments can accurately reproduce two things which have not been adequately reproduced: artworks created with interference pigments; and biological organisms exhibiting interference colors. Otherwise, the R′G′B′Y′ process can be regarded as an improved method for decorative printing, since the intensity of the colors and the brilliance of the finish are so different from conventional color processes.

The R′G′B′Y′ process can be used for many types of printed products, including, but not limited to, posters, signs, book covers, greeting cards, gift wrapping papers, wallpapers, packages, and labels. It can be regarded as a special effect, but with the important difference that, unlike many special effects which are created on a job-to-job basis, the R′G′B′Y′ process is standardizable, controllable, and repeatable.

Tables

TABLE 1
Mixes of trichromatic additive primary colors (RGB), emitters.

| Colors mixed | | | Resulting color | Coordinates |
|---|---|---|---|---|
| — | — | — | dark gray | (0, 0, 0) |
| red | — | — | red | (1, 0, 0) |
| — | green | — | green | (0, 1, 0) |
| — | — | blue | blue | (0, 0, 1) |
| red | green | — | yellow | (1, 1, 0) |
| — | green | blue | cyan | (0, 1, 1) |
| red | — | blue | magenta | (1, 0, 1) |
| red | green | blue | white | (1, 1, 1) |

TABLE 2
Mixes of trichromatic subtractive primary colors (CMY), filters.

| Colors mixed | | | Resulting color | Coordinates |
|---|---|---|---|---|
| — | — | — | white | (0, 0, 0) |
| cyan | — | — | cyan | (1, 0, 0) |
| — | magenta | — | magenta | (0, 1, 0) |
| — | — | yellow | yellow | (0, 0, 1) |
| — | magenta | yellow | red | (0, 1, 1) |
| cyan | — | yellow | green | (1, 0, 1) |
| cyan | magenta | — | blue | (1, 1, 0) |
| cyan | magenta | yellow | dark brown | (1, 1, 1) |

TABLE 3
Mixes of tetrachromatic interference primary colors (R′G′B′Y′),
reflectors.

| Colors mixed | | | | Resulting color | Coordinates |
|---|---|---|---|---|---|
| — | — | — | — | black | (0, 0, 0, 0) |
| red | — | — | — | red | (1, 0, 0, 0) |
| — | green | — | — | green | (0, 1, 0, 0) |
| — | — | blue | — | blue | (0, 0, 1, 0) |
| — | — | — | yellow | yellow | (0, 0, 0, 1) |
| red | green | — | — | gray | (1, 1, 0, 0) |
| red | — | blue | — | purple | (1, 0, 1, 0) |
| red | — | — | yellow | orange | (1, 0, 0, 1) |
| — | green | blue | — | cyan | (0, 1, 1, 0) |
| — | green | — | yellow | yellow-green | (0, 1, 0, 1) |
| — | — | blue | yellow | gray | (0, 0, 1, 1) |
| red | green | blue | — | light blue | (1, 1, 1, 0) |
| red | green | — | yellow | light yellow | (1, 1, 0, 1) |
| red | — | blue | yellow | light red | (1, 0, 1, 1) |
| — | green | blue | yellow | light green | (0, 1, 1, 1) |
| red | green | blue | yellow | white | (1, 1, 1, 1) |

TABLE 4
Raw RGB digital counts for 100% R′G′B′Y′ inks.

| Color | R | G | B |
|---|---|---|---|
| R′ | 255 | 86 | 123 |
| G′ | 116 | 252 | 193 |
| B′ | 21 | 135 | 255 |
| Y′ | 249 | 211 | 94 |

TABLE 5
Raw rgb coordinates of the R′G′B′Y′ colors.

| Color | r | g | b |
|---|---|---|---|
| R′ | 0.54957 | 0.18534 | 0.26509 |
| G′ | 0.20677 | 0.44920 | 0.34403 |
| B′ | 0.05109 | 0.32847 | 0.62044 |
| Y′ | 0.44946 | 0.38087 | 0.16968 |

TABLE 6
Normalized rgb coordinates of the R′G′B′Y′ colors.

| Color | r | g | b |
|---|---|---|---|
| R′ | 0.67460 | 0 | 0.32504 |
| G′ | 0 | 0.56629 | 0.43371 |
| B′ | 0 | 0.34616 | 0.65384 |
| Y′ | 0.54130 | 0.45870 | 0 |

TABLE 7
Halftone transfer curve in % dot area.

| Input | Output |
|---|---|
| 0 | 0 |
| 5 | 1 |
| 10 | 3 |
| 15 | 4 |
| 20 | 6 |
| 25 | 8 |
| 30 | 11 |
| 35 | 15 |
| 40 | 19 |
| 45 | 23 |
| 50 | 28 |
| 55 | 33 |
| 60 | 39 |
| 65 | 45 |
| 70 | 51 |
| 75 | 58 |
| 80 | 65 |
| 85 | 73 |
| 90 | 81 |
| 95 | 90 |
| 100 | 100 |

TABLE 8
Summary comparison of characteristics for RGB CRT display, CMYK
printing, and R′G′B′Y′ printing.

| Characteristic | RGB | CMYK | R′G′B′Y′ |
|---|---|---|---|
| colorant type | phosphors | dyes | pigments |
| chemistry | inorganic | organic | inorganic |
| chemical type | rare earths | aromatic | refractory |
| | | carbon | oxides |
| toxicity | toxic | some toxic | nontoxic |
| manufacturing type | electronic | pharmaceutical | nano-materials |
| display mechanism | emission | transmission | reflection |
| substrate color | dark gray | white | black |
| bandwidth | narrow | broad | broad |
| mixing type | additive | subtractive | additive |
| mixing law | trichromatic | trichromatic | tetrachromatic |
| vision theory | Young-Helmholtz | Young- | Hering |
| | | Helmholtz | |
| reflection view | powered display | ambient light | ambient light |
| transmission view | none | ambient light | ambient light |
| projection | powered display | film projector | opaque |
| | | | projector |
| image permanence | ephemeral | fading | nonfading |
| image archiving | data | data or film | data, film, or |
| | | | print |
| data file size | 3 bytes per pixel | 4 bytes per | 4 bytes per |
| | | pixel | pixel |
| separation | RGB to RGB | RGB to CMYK | RGB to |
| | | | R′G′B′Y′ |
| separation method | matrix transform | empirical | matrix |
| | | | transform |
| color space | three dimensions | four | four |
| | | dimensions | dimensions |

Equations

RGB digital counts are converted to rgb coordinates by:
r=R/(R+G+B), (EQU. 1.1)
g=G(R+G+B), and (EQU. 1.2)
b=B/(R+G+B). (EQU. 1.3)

To separate the desired image the RGB file is converted to R′G′B′Y′ by:
R′=(Rr_{R′}+Gg_{R′}+Bb_{R′}), (EQU. 2.1)
G′=(Gr_{G′}+Gg_{G′}+Bb_{G′}), (EQU. 2.2)
B′=(Rr_{B′}+Gg_{B′}+Bb_{B′}), and (EQU. 2.3)
Y′=(Rr_{Y′}+Gg_{Y′}+Bb_{Y′}). (EQU. 2.4)

Halftone transfer curves are generated by the four-color solution to the DeMichel-Neugebauer equations with all printing areas set as equal:
A=4a−3a²+2a³−a⁴. (EQU. 3)
Notes on the References Cited

U.S. Pat. No. 4,242,428 to Davis (1980) discloses a method of producing monochromatic images of a desired color by incorporating interference pigments into silver halide and other photosensitive emulsions. Davis also proposes the use of multiple, differentially sensitized emulsion layers similar to those used in conventional color photographic films and papers. This patent is referenced to show a previous method of incorporating interference pigments into a nominally black and white photographic system. This patent teaches the additive RGB color mixing laws and the subtractive CMY color mixing laws. The disadvantages of this system are: it is unsuitable for mass production of prints, because it is a one-at-a-time darkroom process; it has a low range of density values (contrast); and it uses premixed colors, but does not produce full color images.

U.S. Pat. No. 5,161,974 to Bourges (1992) teaches a premixed set of colorants composed of the same inks used in CMYK printing. When such a set of colorants is used for the creation of original works of art, the accuracy of the printed reproductions is greatly improved. The premixed colors have been completely characterized by CIE colorimetry. This system is only applicable to conventional CMYK printing.

U.S. Pat. No. 5,370,976 to Williamson et al. (1994) describes a method of printing metallic gold and/or silver inks into selected areas of a conventionally scanned CMYK image. This patent is referenced to show that a method of combining full color with a metallic finish is a desirable goal and a continuing challenge. It discusses the problem of moiré patterns that occur when more than three color halftones are overprinted. This method produces attractive and subtle images, but it is expensive.

U.S. Pat. No. 5,734,800 to Herbert et al. (1998) discloses a six-color process system that adds an orange and a green ink to the usual CMYK set. This method is dependent on extensive color charts that must be well characterized by CIE colorimetry. A large look-up-table (LUT) is required. This patent is referenced to show that the development of color separation and printing systems including more than the conventional CMYK inks is a continuing challenge. It shows comparisons of the gamuts of different color printing systems, and also discusses the problem of the moiré patterns that occur when more than three color halftones are overprinted. The fluorescent inks show more rapid fading than the conventional CMYK inks.

U.S. Pat. No. 6,459,501 B1 to Holmes (2002) teaches a method of premixing selected gray inks with each of the CMY inks to create a reduced chroma system (including black ink). This method is an improvement to the practice of reproducing nominally black and white images with CMYK printing systems. This patent shows comparisons of the gamuts of different color printing systems, in this case a smaller gamut is compared to the gamut of conventional CMYK printing.

U.S. Pat. No. 6,724,500 B1 to Hains et al. (2004) teaches a method of transforming RGB coordinates into CMYK coordinates by using the CIELAB Uniform Color Space as an intermediate system. This method produces an efficiently addressed LUT, but the ink set must be well characterized by CIE colorimetry. This patent is referenced to show that the development of faster and more accurate methods for color separation is a continuing challenge. It teaches that an additive color space can be converted to another additive color space by matrix transformation. It also teaches the use of a fourth-degree polynomial expression for the purpose of gamut compression. This system is mainly applicable to consumer type desktop printers.

Billmeyer and Saltzman's Principles of Color Technology by Roy S. Berns discusses most aspects of color production and reproduction. Particularly relevant sections are: pages 143-146 on color gamuts; pages 151-170 on additive color mixing laws; and pages 170-174 on halftoning. This text teaches the use of the DeMichel-Neugebauer system of equations for the analysis of color halftones.

Color Appearance Models by Mark D. Fairchild describes and compares most of the color models that are in current use. Particularly relevant sections are: pages 199-121, 125, and 274-278 on opponent color systems.

Color and Its Reproduction by Gary G. Field is a state-of-the-art text on conventional CMYK process color reproduction. Particularly relevant sections are: pages 1-12 on the history of color reproduction; pages 15-17 on additive color; pages 110-112 on the Bourges patent listed above; pages 147-153 on printing methods; pages 159-162 on dot gain; and pages 305-311 on output resolution. This text also teaches the use of the DeMichel-Neugebauer system of equations for the analysis of color halftones.

In Pigment Handbook, L. M. Greenstein's chapter “Nacreous (Pearlescent) Pigments and Interference Pigments” describes the chemical, physical, and optical characteristics of the interference pigments, as well as their manufacture and use. Many new types of interference pigments have been invented since this book was published.

Color Science: Concepts and Methods, Quantitative Data and Formulae by Günter Wyszecki and W. S. Stiles is the basic text on colorimetry. It gives the CIE mathematical methods and data tables that are required for the computation and graphic representation of chromaticity diagrams and three-dimensional color spaces.

What is claimed is:

1. An additive system for process color separation and printing using a set of primary colorant materials comprising interference pigments.

2. The system for process color separation and printing of claim 1 in which said set of primary colorant materials consists of the unique opponent colorant materials:
interference red, interference green, interference blue, interference gold; and
four pigmented vehicles, each containing one of the said set of primary colorant materials.

3. The system for process color separation and printing of claim 2 further including a means for initial calibration comprising:
a device for the application of said four pigmented vehicles onto a black substrate;
said four pigmented vehicles applied to said black substrate as four swatches;
additional swatches of neutral black, white, and intermediate gray or grays;
a device for recording the colors of all the swatches as red, green, and blue digital counts; and
a device for converting said red, green, and blue digital counts into normalized red, green, and blue decimal coordinates.

4. The system for process color separation and printing of claim 3 further including a means for producing color separations from a red, green, and blue image file comprising:
a device for recording, transmitting, or generating a red, green, and blue image file;
a device for converting said red, green, and blue image file into an interference red, interference green, interference blue, and interference gold image file or four corresponding grayscale files using parameters determined from said normalized red, green, and blue decimal coordinates; and
a device for converting said interference red, interference green, interference blue, and interference gold image file or said four corresponding grayscale files into four corresponding halftone images.

5. The system for process color separation and printing of claim 4 further including a means for printing comprising:
a device for the sequential or simultaneous printing of said four corresponding halftone images using each of said four corresponding pigmented vehicles; and
a black substrate for the reception of said four corresponding pigmented vehicles.

6. The system for process color separation and printing of claim 5 further including another means for producing color separations from a color photographic print, transparency, artwork, or other object comprising:
a set of three color filters having peak wavelengths and bandwidths matched to those of the video red, green, and blue colors;
a device for the sequential or simultaneous recording of three corresponding grayscale images of a color photographic print, transparency, artwork, or other object using said set of three color filters;
a device for compositing said three corresponding grayscale images into four interference red, interference green, interference blue, and interference gold grayscale images using parameters determined from said normalized red, green, and blue decimal coordinates; and
a device for converting said four interference red, interference green, interference blue, and interference gold grayscale images into four corresponding halftone images.

7. The system for process color separation and printing of claim 6 further including another means for producing color separations from a color photographic print, transparency, artwork, or other object comprising:
a set of four narrowband color filters having peak transmission wavelengths matched to the peak reflection wavelengths of said four pigmented vehicles as applied to said black substrate;
a device for the sequential or simultaneous recording of four corresponding grayscale images of a color photographic print, transparency, artwork, or other object using said set of four narrowband color filters; and
a device for converting said four corresponding grayscale images into four corresponding halftone images.

8. The system for process color separation and printing of claim 7 further including a printing device that does not require halftoning.

9. The system for process color separation and printing of claim 8 further including an opaque substrate of a color other than black.

10. The system for process color separation and printing of claim 9 further including a selected subset of said set of primary colorant materials.

11. The system for process color separation and printing of claim 10 further including other colorant materials in addition to said set of primary colorant materials.

12. The system for process color separation and printing of claim 11 further including a white interference pigment printed in the highlight areas of the image.

13. The system for process color separation and printing of claim 12 further including a subtractive mode of operation comprising: a transparent or translucent substrate on which the color halftones are printed with said pigmented vehicles of the corresponding opponent colors.

14. The subtractive mode of operation of the system for process color separation and printing of claim 13 further including a colored transparent or translucent substrate.

15. An additive system for process color separation and printing comprising: a set of primary colorant materials selected from interference pigments; a transparent or translucent vehicle into which said primary colorant materials are separately incorporated; a black substrate for the reception of the pigmented vehicles; a device for determining the calorimetric parameters of said pigmented vehicles as applied to said black substrate; a device for producing color separations using parameters derived from said calorimetric parameters; and a device whereby said color separations are printed using said pigmented vehicles on said black substrate.

16. A system for process color printing using a set of primary colorant materials selected from interference pigments.
